(19) United States
(12) Patent Application Publication
(10) Pub. No.: US 2025/0226872 A1
(43) Pub. Date: Jul. 10, 2025

(54) PRECODER MATRIX INDICATOR (PMI)-ASSISTED USER EQUIPMENT (UE) SPATIAL RELATIONSHIP ESTABLISHMENT

(71) Applicant: TELEFONAKTIEBOLAGET LM ERICSSON (PUBL), Stockholm (SE)

(72) Inventors: CHAOCHENG TU, KANATA (CA); KEVIN LUO, NEPEAN (CA); JOSÉ MARIA GARCIA PERERA, HELSINGBORG (SE); YONGQUAN QIANG, OTTAWA (CA)

(21) Appl. No.: 18/846,042

(22) PCT Filed: Jan. 27, 2023
(86) PCT No.: PCT/IB2023/050732

§ 371 Date: Sep. 11, 2024

Related U.S. Application Data
(60) Provisional application No. 63/304,227, filed on Jan. 28, 2022.

(51) Int. Cl. H04B 7/06

(52) U.S. Cl. CPC H04B 7/0639

(57) ABSTRACT

A method, system and apparatus for precoder matrix indicator (PMI) assisted user equipment (UE) spatial relationship establishment are disclosed. According to one aspect, a method in a network node includes receiving a plurality of precoding matrix indicators (PMI) from a plurality of UEs. The method also includes determining harmonized PMI among the received PMI, and establishing a spatial relationship for UEs from which the harmonized PMI are received based at least in part on the harmonized PMI.

### FIELD

The present disclosure relates to wireless communications, and in particular, to precoder matrix indicator (PMI) assisted user equipment (UE) spatial relationship establishment.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile user equipment (UE), as well as communication between network nodes and between UEs. Standards for Sixth Generation (6G) wireless communication systems are under development.

In 3GPP Technical Release 15 (3GPP Rel-15) for NR, the “Type-1 Single Panel” codebook is introduced for single user multiple input multiple output (SU-MIMO). A two-dimensional discrete Fourier transform (DFT) codebook has been defined for configured channel state information reference signals (CSI-RS ports). The precoding matrix W is further described as a two-stage precoding structure as following:

$$W = {W}_{1} {W}_{2}$$

where W₁ consists of a group of 2D grid-of-beams (GoB) denoted by:

$${W}_{1} = [ \begin{matrix}{v}_{l} ⊗ {v}_{m} & 0 \\ 0 & {v}_{l} ⊗ {v}_{m}\end{matrix} ]$$

where, vᵢ and vₘ are precoding vectors selected from over-sampled DFT matrix for horizontal direction and vertical direction, expressed by:

$${v}_{l} = {\frac{1}{\sqrt{{N}_{1}}} [ 1 , {e}^{\frac{j 2 π}{{N}_{1} {O}_{1}}} , ... , {e}^{\frac{j 2 π ( {N}_{1} - 1 ) l}{{N}_{1} {O}_{1}}} ]}^{T}$$

$${v}_{m} = {\frac{1}{\sqrt{{N}_{2}}} [ 1 , {e}^{\frac{j 2 π}{{N}_{2} {O}_{2}}} , ... , {e}^{\frac{j 2 π ( {N}_{2} - 1 ) m}{{N}_{2} {O}_{2}}} ]}^{T}$$

where, N₁, N₂ are configured CSI-RS ports in horizontal and vertical direction, with corresponding over-sampling rate of O₁, O₂.

The values of N₁, N₂ are configured with the higher layer parameter n1-n2, respectively. Each UE may be configured with different N₁, N₂ depending on various factors such as UE capability. The supported configurations (N₁, N₂) for a given number of CSI-RS ports and the corresponding values of (O₁, O₂) are given in Table 1.

TABLE 1

| Number of | | |
|---|---|---|
| CSI-RS antenna | | |
| ports, P_{CSI-RS} | (N₁, N₂) | (O₁, O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

W₂ from the aforementioned two-stage precoding structure is used for beam selection within W₁ and co-phasing between two polarizations.

For single layer transmission:

$${W}_{2} = \frac{1}{\sqrt{2}} [ \begin{matrix}1 \\ {φ}_{n}\end{matrix} ]$$

For dual layer transmission:

$${W}_{2} = \frac{1}{2} [ \begin{matrix}1 & 1 \\ {φ}_{n} & - {φ}_{n}\end{matrix} ]$$

Where φₙ is the co-phasing factor determined by the UE-reported wideband or subband co-phasing index n, denoted by:

$${φ}_{n} = {e}^{j π n / 2}$$

The 2D PMI (l, m) and co-phasing index n are obtained from the UE PMI report with “Type-1 Single Panel” codebook.

In various 5G NR applications, it may be beneficial to establish the spatial relationship among UEs, such as determining UE location distributions, or whether UEs have good separation. For 5G NR, the active antenna system (AAS) is one of the key technologies adopted by 4G LTE and 5G NR to enhance wireless network performance and capacity. AAS relies on large number of antennas (>>8), also known as full dimension multiple-input multiple-output (FD-MIMO) or massive MIMO in 3GPP. Both horizontal beamforming and vertical beamforming are therefore possible with the AAS and hence, their spatial relationship may be established from the CSI report in which essentially a preferred beam direction in three dimensional spaces is reported by the UE.

3GPP Rel-15 specifications provide a mechanism for the network node (e.g., gNB) to collect a UE's spatial information via the CSI report on a per-UE basis; however, it is not clear how to harmonize applications involving multiple UEs with possibly different configurations. In addition, there is no requirement from the 3GPP to establish a spatial relationship for multiple UEs.

### SUMMARY

Methods and network nodes for precoder matrix indicator (PMI) assisted user equipment (UE) spatial relationship establishment are disclosed.

Note that once the spatial relationship for multiple UEs has been established, it may be beneficial for many applications such as beamforming-based sectorization, multi-user (MU)-multiple input-multiple output (MIMO) demodulation reference signal (DMRS) port assignments, sCell selection optimization, etc. There are also limitations upon relying on the codebooks configured for collecting UE's spatial information. The UEs may be either co-located or covered within the same wide beam making their spatial relationship indeterminate.

Some embodiments provide methods and network nodes for precoder matrix indicator (PMI) assisted user equipment (UE) spatial relationship establishment.

Methods and network nodes for PMI-assisted UE spatial relationship establishment for various applications in 5G NR are disclosed. Specifically, some embodiments are configured to take the following factors into consideration:
The UEs may be located in anywhere. Some of them may be closer to each other. For the UEs that are close to each other, they may or may not be distinguished from the codebook employed by the gNB;
The UEs may each be configured with different CSI-RS configurations; and
The UEs may assume different Type-1 Single-Panel codebooks when the rank is greater than 2.

The spatial relationship may be updated in every transmission time interval (TTI) and on a per-cell-basis in case the spatial relationship of the associated UEs is indeterminate.

The solutions provided by some embodiments are applicable to beamforming-based UE sectorization, MU-MIMO DMRS ports assignment, sCell selection optimization, etc., in 5G NR.

In some embodiments, the solution is summarized by the following steps by the network node (e.g., gNB):
Step 1: Harmonize PMIs or PMI distances (PMIDs) from different CSI-RS configurations and codebooks:
   For the received PMIs or the derived PMIDs, the network node may take different CSI-RS configurations and Type-1 Single-Panel codebooks (applicable when the UE-reported rank is larger than 2) into consideration. For the pairwise PMID between any two MU-MIMO UEs, the PMID comprises both the horizontal and vertical PMIDs and may have a suitable combining factor for these two PMIDs; and/or
Step 2: Establish the spatial relationship of the UEs.

The spatial relationship among UEs may be established based on the harmonized PMIs or the pairwise PMIDs. This may be achieved for example by projecting the harmonized PMIs onto a new reference line, or by following a series of steps to exploit a combination of the harmonized PMIDs according to the disclosed algorithms.

Some embodiments establish UE spatial relationships for various applications in 5G NR. In some embodiments, the solution relies on the reported PMI's which are part of the CSI reports sent by the UEs. In some embodiments, a solution is flexible to accommodate UEs with different CSI-RS configurations and codebooks. Some embodiments may also introduce various algorithms to establish UE spatial relationships from the PMIs or pairwise PMIDs. The notion of pairwise PMIDs described in the algorithms may be replaced by an orthogonality check or other similar measure. In case the spatial relationship from one or more UEs is indeterminate, the solution provides a randomization mechanism to minimize the possible impact on performance.

According to one aspect, a network node configured to communicate with a user equipment (UE) is provided. The network node includes processing circuitry configured to: receive a plurality of precoding matrix indicators, PMI, from a plurality of UEs; determine harmonized PMI among the received PMI; and establish a spatial relationship for UEs from which the harmonized PMI are received based at least in part on the harmonized PMI.

According to this aspect, in some embodiments, establishing the spatial relationship for the UEs includes projecting the harmonized PMIs to a reference line. In some embodiments, establishing the spatial relationship for the UEs includes sorting the projected harmonized PMIs into a predetermined method of order. In some embodiments, establishing the spatial relationship for the UEs includes selecting a first UE associated with one of a maximum value and a minimum value of a distance parameter based at least in part on the harmonized PMIs. In some embodiments, establishing the spatial relationship for the UEs includes selecting a second UE associated with the minimum value of the distance parameter. In some embodiments, the distance parameter is based at least in part on a determined value of:

$${d}_{i , j} = PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} ;$$

where (l′ᵢ, m′ᵢ) indicate respective horizontal and vertical beam indices and β is a factor based at least in part on the harmonized PMI. In some embodiments, establishing the spatial relationship includes selecting remaining UEs based at least in part on the distance parameter of each remaining UE. In some embodiments, selecting a remaining UE includes comparing the distance parameter to the distance parameter of the first UE. In some embodiments, selecting a remaining UE includes selecting a UE associated with the minimum value of the distance parameter. In some embodiments, the processing circuitry is further configured to determine a beam direction based at least in part on the harmonized PMI.

According to another aspect, a method implemented in a network node that is configured to communicate with a wireless device is provided. The method includes: receiving a plurality of precoding matrix indicators, PMI, from a plurality of UEs; determining harmonized PMI among the received PMI; and establishing a spatial relationship for UEs from which the harmonized PMI are received based at least in part on the harmonized PMI.

According to this aspect, in some embodiments, establishing the spatial relationship for the UEs includes projecting the harmonized PMIs to a reference line. In some embodiments, establishing the spatial relationship for the UEs includes sorting the projected harmonized PMIs into a predetermined method of order. In some embodiments, establishing the spatial relationship for the UEs includes selecting a first UE associated with one of a maximum value and a minimum value of a distance parameter based at least in part on the harmonized PMIs. In some embodiments, establishing the spatial relationship for the UEs includes selecting a second UE associated with the minimum value of the distance parameter. In some embodiments, the distance parameter is based at least in part on a determined value of:

$${d}_{i , j} = PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} ;$$

where (l′ᵢ, m′ᵢ) indicate respective horizontal and vertical beam indices and β is a factor based at least in part on the harmonized PMI. In some embodiments, establishing the spatial relationship includes selecting remaining UEs based at least in part on the distance parameter of each remaining UE. In some embodiments, selecting a remaining UE includes comparing the distance parameter to the distance parameter of the first UE. In some embodiments, selecting a remaining UE includes selecting a UE associated with the minimum value of the distance parameter. In some embodiments, the method also includes determining a beam direction based at least in part on the harmonized PMI.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of a network node in communication with a wireless device over a wireless connection according to some embodiments of the present disclosure;

FIG. 3 is a flowchart of an example process in a network node for precoder matrix indicator (PMI) assisted user equipment (UE) spatial relationship establishment according to some embodiments of the present disclosure;

FIG. 4 is an example of PMI-assisted UE spatial relationship establishment in 5G NR;

FIG. 5 is a flowchart of an example process according to principles disclosed herein;

FIG. 6 is an example of applying sectorization from harmonized PMIs;

FIG. 7 is an example of establishment of spatial relationships by projecting harmonized PMIs to a new reference line;

FIG. 8 is an example of establishment of spatial relationships of a third UE and onward in a MU-MIMO group;

FIG. 9 is another example of establishment of spatial relationships of a third UE and onward in a MU-MIMO group; and

FIG. 10 is an example O-RAN implementation for PMI-assisted spatial relationship establishment.

### DETAILED DESCRIPTION

Before describing in detail example embodiments, it is noted that the embodiments reside primarily in combinations of apparatus components and processing steps related to precoder matrix indicator (PMI) assisted user equipment (UE) spatial relationship establishment. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a user equipment (UE) such as a wireless device (WD) or a radio network node.

In some embodiments, the non-limiting terms wireless device (WD) or a user equipment (UE) are used interchangeably. The UE herein may be any type of wireless device capable of communicating with a network node or another UE over radio signals, such as wireless device (WD). The UE may also be a radio communication device, target device, device to device (D2D) UE, machine type UE or UE capable of machine to machine communication (M2M), low-cost and/or low-complexity UE, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to precoder matrix indicator (PMI) assisted UE spatial relationship establishment.

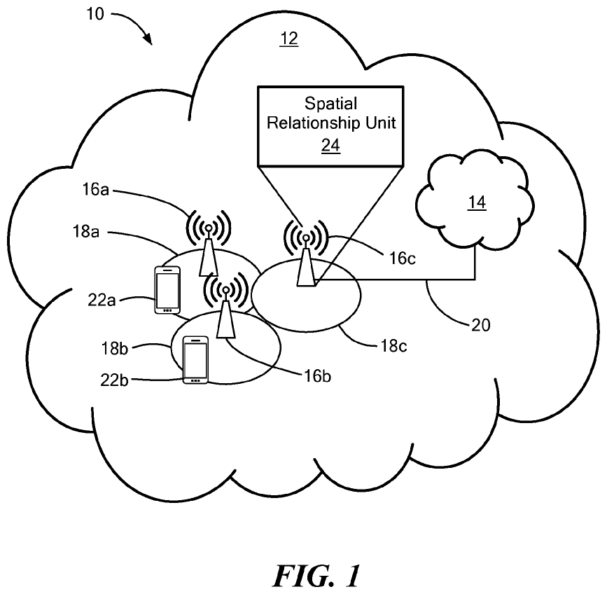

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as UEs 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN and a gNB for NR/NG-RAN.

A network node 16 (eNB or gNB) is configured to include a spatial relationship unit 24 which is configured to establish a spatial relationship for UEs from which the harmonized PMI are received based at least in part on the harmonized PMI.

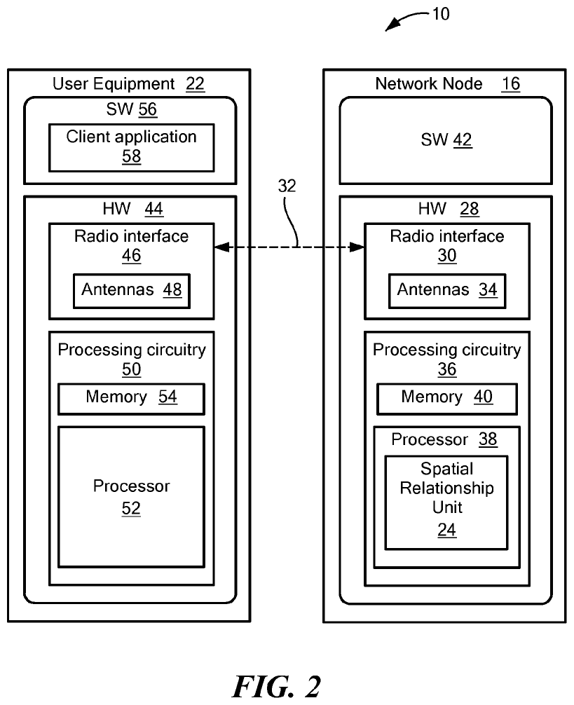

Example implementations, in accordance with an embodiment, of the UE 22 and network node 16 discussed in the preceding paragraphs will now be described with reference to FIG. 2.

The communication system 10 includes a network node 16 provided in a communication system 10 and including hardware 28 enabling it to communicate with the UE 22. The hardware 28 may include a radio interface 30 for setting up and maintaining at least a wireless connection 32 with a UE 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a spatial relationship unit 24 which is configured to establish a spatial relationship for UEs from which the harmonized PMI are received based at least in part on the harmonized PMI.

The communication system 10 further includes the UE 22 already referred to. The UE 22 may have hardware 44 that may include a radio interface 46 configured to set up and maintain a wireless connection 32 with a network node 16 serving a coverage area 18 in which the UE 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the UE 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 56, which is stored in, for example, memory 54 at the UE 22, or stored in external memory (e.g., database, storage array, network storage device, etc.) accessible by the UE 22. The software 56 may be executable by the processing circuitry 50. The software 56 may include a client application 58. The client application 58 may be operable to provide a service to a human or non-human user via the UE 22.

The processing circuitry 50 may be configured to control any of the methods and/or processes described herein and/or to cause such methods, and/or processes to be performed, e.g., by UE 22. The processor 52 corresponds to one or more processors 52 for performing UE 22 functions described herein. The UE 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to UE 22.

In some embodiments, the inner workings of the network node 16 and UE 22 may be as shown in FIG. 2 and independently, the surrounding network topology may be that of FIG. 1.

The wireless connection 32 between the UE 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 1 and 2 show various “units” such as spatial relationship unit 24 as being within a respective processor, it is contemplated that these units may be implemented such that a portion of the unit is stored in a corresponding memory within the processing circuitry. In other words, the units may be implemented in hardware or in a combination of hardware and software within the processing circuitry.

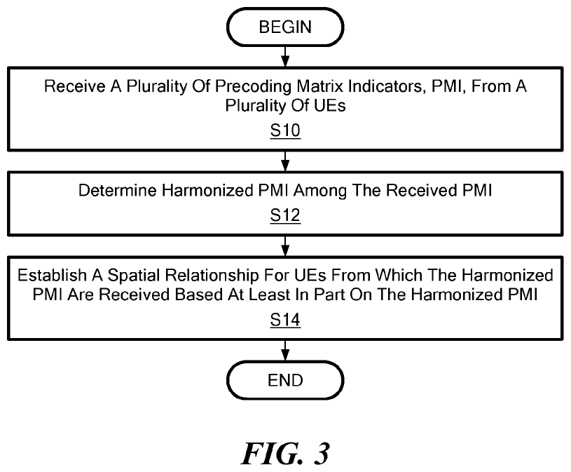

FIG. 3 is a flowchart of an example process in a network node 16 for precoder matrix indicator (PMI) assisted user equipment (UE) spatial relationship establishment. One or more blocks described herein may be performed by one or more elements of network node 16 such as by one or more of processing circuitry 36 (including the spatial relationship unit 24), processor 38, and/or radio interface 30. Network node 16 such as via processing circuitry 36 and/or processor 38 and/or radio interface 30 is configured to receive a plurality of precoding matrix indicators, PMI, from a plurality of UEs (Block S10). The process also includes determining harmonized PMI among the received PMI (Block S12). The process also includes establishing a spatial relationship for UEs from which the harmonized PMI are received based at least in part on the harmonized PMI (Block S14).

In some embodiments, establishing the spatial relationship for the UEs includes projecting the harmonized PMIs to a reference line. In some embodiments, establishing the spatial relationship for the UEs includes sorting the projected harmonized PMIs into a predetermined method, e.g., ascending, of order. Of course, implementations are not limited to ascending order, and may be in some other order, e.g., descending order, based on the particular needs and desires of the implementation. In some embodiments, establishing the spatial relationship for the UEs includes selecting a first UE associated with one of a maximum value and a minimum value of a distance parameter based at least in part on the harmonized PMIs. In some embodiments, establishing the spatial relationship for the UEs includes selecting a second UE associated with a minimum value of the distance parameter. In some embodiments, the distance parameter is based at least in part on a determined value of:

$${d}_{i , j} = PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} ;$$

where (l′ᵢ, m′ᵢ) indicate respective horizontal and vertical beam indices and β is a factor based at least in part on the harmonized PMI. In some embodiments, establishing the spatial relationship includes selecting remaining UEs based at least in part on the distance parameter of each remaining UE. In some embodiments, selecting a remaining UE includes comparing the distance parameter to a distance parameter of the first UE. In some embodiments, selecting a remaining UE includes selecting a UE associated with a minimum value of the distance parameter. In some embodiments, the process also includes determining a beam direction based at least in part on the harmonized PMI.

Having described the general process flow of arrangements of the disclosure and having provided examples of hardware and software arrangements for implementing the processes and functions of the disclosure, the sections below provide details and examples of arrangements for precoder matrix indicator (PMI) assisted user equipment (UE) spatial relationship establishment.

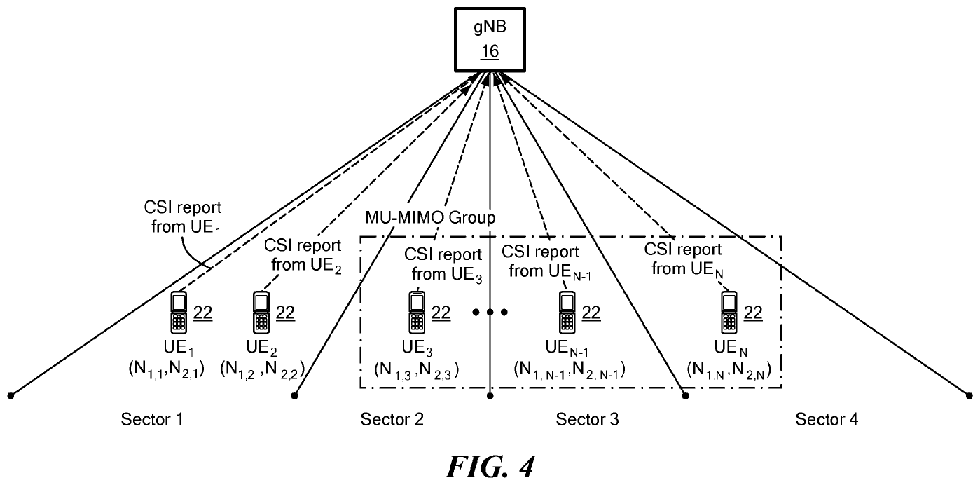

An example of PMI-assisted UE spatial relationship establishment is illustrated in FIG. 4, in which each UE 22 may be configured with different CSI-RS settings (N₁,N₂). In one example, the network node 16 may establish a UE spatial distribution based on the CSI reports sent by the UEs 22. Once the statistics of the spatial distribution of the UEs 22 have been established, the network node 16 may properly apply beam-pattern-based sectorization in a manner that statistically optimizes the beam patterns pointing toward the UEs 22 in a sector. In another example, the network node 16 may establish the spatial relationship of the UEs 22 within the MU-MIMO group based on the CSI reports sent by the UEs 22. Once the spatial relationship has been established, the UEs 22 in the MU-MIMO group may be queued in an order based on their spatial relationship for the next step. Then, the network node 16 may efficiently assign limited DMRS ports in a manner that UEs 22 in consideration, occupy DMRS ports that are interfered with as little as possible by other UEs 22 being assigned to the same DMRS ports.

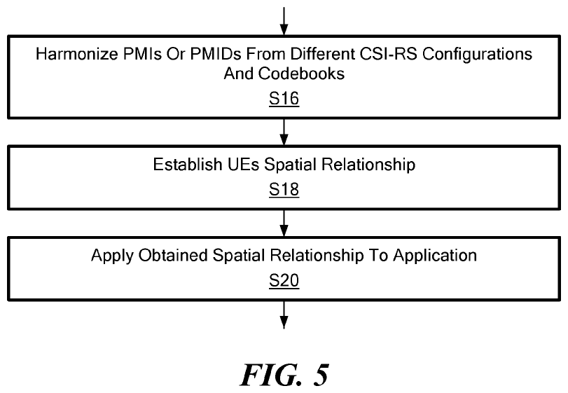

As illustrated in the example of FIG. 5, a solution implemented by some embodiments may be summarized by the following steps performed by the network node 16:
Step 1: Harmonize PMIs or PMIDs from different CSI-RS configurations and codebooks (Block S16);
Step 2: Establish UE spatial relationships (Block S18); and
Step 3: Apply the established spatial relationships (Block S20).

Note that even though pairwise PMIDs are employed in this application, other similar measures such as orthogonality check between UEs 22 that may be translated into a UE spatial relationship such as the degree of closeness may also be applicable:

Step 1: Harmonize PMIs or PMIDs from Different CSI-RS Configurations and Codebooks

In 3GPP Rel-15, the UE 22 configured with the “Type-1 Single-Panel” codebook will report rank indicator (RI), channel quality indicator (CQI), and PMI (i₁₁, i₁₂, i₁₃, i₂) from their CSI report. Let (l, m) be denoted as

$$( l , m ) = ( {i}_{1 , 1} , {i}_{1 , 2} ) ,$$

which may be derived from the reported PMI, representing the preferred horizontal and vertical beam (for the first layer). In other words, (l, m) may essentially represent the UE's location, from the codebook's perspective. In a time division duplex (TDD) system, such information may also be derived through uplink (UL) reference signals (e.g., sounding reference signals (SRS) or physical uplink shared channel (PUSCH) DMRS).

Before establishing a spatial relationship for a group of UEs 22, the network node 16 may consider, for example:
The UEs 22 may be configured with different CSI-RS configurations;
The UEs 22 may be assumed by different codebooks (e.g., when the RI>2, there are different codebooks for CSI-RS ports≥16. For the former case, the range of i₁₁ is twice as large as the latter's case's range); and/or
A combination of two or more of the above.

Let (N_{1,i}, N_{2,i}) and (lᵢ, mᵢ), i=1, . . . , N represent the CSI-RS configurations and PMIs derived from CSI reports of the UEs 22 in consideration, respectively. To accommodate possibly different CSI-RS configurations, the network node 16 may first identify the least common multiple functions from the horizontal and vertical domains (N_{1,i}, N_{2,i}), respectively. That is:

$$n 1 Lcm = lcm ( {N}_{1 , 1} {O}_{1 , 1} , {N}_{1 , 2} {O}_{1 , 2} , … , {N}_{1 , N} {O}_{1 , N} )$$

$$n 2 Lcm = lcm ( {N}_{2 , 1} {O}_{2 , 1} , {N}_{2 , 2} {O}_{2 , 2} , … , {N}_{2 , N} {O}_{2 , N} ) .$$

Then lᵢ and mᵢ, i=1, . . . , N, may be scaled up by the scaling factor

$$\frac{n 1 Lcm}{{N}_{1 , i} {O}_{1 , i}} and \frac{n 2 Lcm}{{N}_{2 , i} {O}_{2 , i}} ,$$

respectively, to the same references for PMIs or pairwise PMID calculations. To accommodate the possibly of different codebooks when the RI>2, the scaling factor may be additionally multiplied by 2 in case the number of CSI-RS ports is ≥16. The transformed (l′ᵢ, m′ᵢ), i=1, . . . , N, may therefore described as:
For i=1, . . . , N:

If (the UE i is configured with CSI-RS ports≥16) AND (RI>2)

$${l}_{i}^{′} = \frac{n 1 Lcm}{{N}_{1 , i} {O}_{1 , i}} \times 2 \times {l}_{i}$$

$$Else$$

$${l}_{i}^{′} = \frac{n 1 Lcm}{{N}_{1 , i} {O}_{1 , i}} \times {l}_{i}$$

$$End$$

$${m}_{i}^{′} = \frac{n 2 Lcm}{{N}_{2 , i} {O}_{2 , i}} \times {m}_{i}$$

$$End$$

In other words, the harmonized PMIs from possibly different CSI-RS configurations and codebooks are denoted as (l′ᵢ, m′ᵢ), i=1, . . . , N.

The harmonized pairwise-PMID between the UEs 22 may be described as

$$PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} , n ∈ R ,$$

$$where :$$

$$\vert {l}_{i}^{′} - {l}_{j}^{′} \vert = min ( mod ( {l}_{i}^{′} - {l}_{j}^{′} , n 1 Lcm ) , mod ( {l}_{j}^{′} - {l}_{i}^{′} , n 1 Lcm ) ) ,$$

$$\vert {m}_{i}^{′} - {m}_{j}^{′} \vert = min ( mod ( {m}_{i}^{′} - {m}_{j}^{′} , n 2 Lcm ) , mod ( {m}_{j}^{′} - {m}_{i}^{′} , n 2 Lcm ) ) ,$$

represent the PMID in the horizontal and vertical direction, respectively. The factor β combines the PMIDs from the two domains and the choice of β may consider for example:
The obtained n1Lcm and n2Lcm from the UEs 22 in consideration;
The gradient of MU-MIMO throughput differences when the PMID is increased in the vertical with respect to the horizontal domain;
The UE orthogonality differences when the PMID is increased in the vertical with respect to the horizontal domain;
The AAS antenna specification used in consideration;
The codebook or beamforming scheme used for DL MU-MIMO; and
The wireless channel profile in consideration, e.g. Urban Macro, Urban Micro, Suburban; and/or
A combination of two or more of the above.

In one example, by considering the obtained n1Lcm, n2Lcm, and the gradient of MU-MIMO throughput differences, then β may be determined as:

$$β = \{ \begin{matrix}0 , & if n 2 Lcm = 1 \\ \frac{n 1 Lcm}{2 \times n 2 Lcm} , & if n 2 Lcm > 1\end{matrix}$$

For the choice of n, in one example, the PMID may be seen as the Euclidean distance if n=2,

$$PMID ( ( {l}_{i}^{′} , {m}_{i}^{′} ) , ( {l}_{j}^{′} , {m}_{j}^{′} ) ) = \sqrt[2]{{\vert {l}_{i}^{′} - {l}_{j}^{′} \vert}^{2} + β {\vert {m}_{i}^{′} - {m}_{j}^{′} \vert}^{2}} ,$$

In another example, the PMID may be seen as the one-norm if n=1,

$$PMID ( ( {l}_{i}^{′} , {m}_{i}^{′} ) , ( {l}_{j}^{′} , {m}_{j}^{′} ) ) = \vert {l}_{i}^{′} - {l}_{j}^{′} \vert + β \vert {m}_{i}^{′} - {m}_{j}^{′} \vert .$$

### Step 2: Establish UE Spatial Relationship

From the harmonized PMIs or PMIDs, the UE spatial relationship for example for the application of UE sectorization may then be established by considering:
The total number of available sectors allowed;
The maximum number of the UEs 22 allowed in a cluster;
The size of the cluster δ in which UEs 22 are considered within a sector, e.g., PMID ((l′ᵢ, m′ᵢ), (l′ⱼ, m′ⱼ))≤δ for any UE 22 associated PMIs (i, j) in the cluster;
The codebook or beamforming scheme used for DL transmissions; and/or
A combination of two or more of the above.

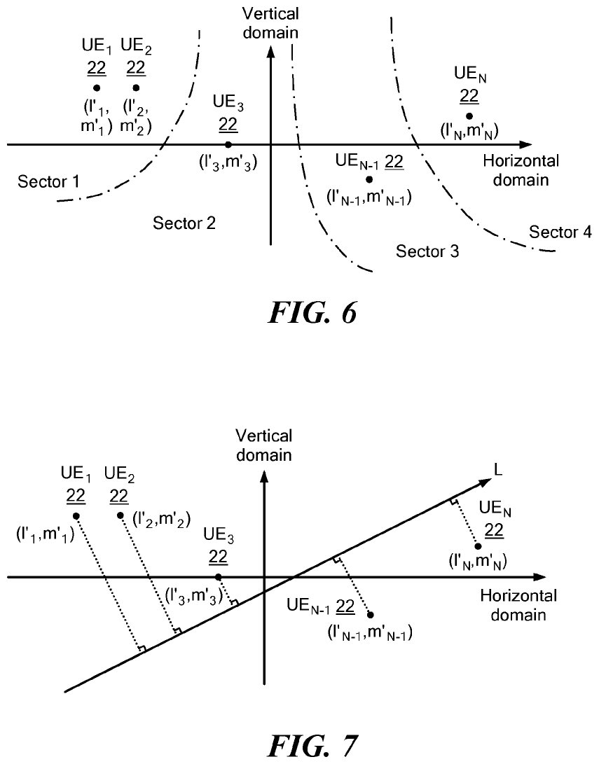

FIG. 6 illustrates an example of how UEs 22 may be sectorized based on their harmonized PMIs or PMIDs into 4 sectors. A classical clustering algorithm, with or without machine learning may be considered for grouping UEs 22 into different sectors.

For the application of MU-MIMO, the spatial relationship may be established by first mapping the harmonized PMIs onto another domain. The mapped data over that domain may be sorted. In one example, the aforementioned mapping may be done by projecting their harmonized PMIs onto a new reference line L. Once the projected values have been obtained, a sorting algorithm sorting by, for example, an ascending order of the projected values may then be applied to establish the MU-MIMO UEs' spatial relationships. FIG. 7 is an example of how UEs 22 may be projected and sorted onto a new reference line based on their harmonized PMIs. In the example, (UE₁, UE₂, . . . , UE_{N}) may be seen as an ordered list of UEs 22 with respect to their spatial locations.

In another example, their spatial relationship may be established by the harmonized PMIDs. Let

$${d}_{i , j} = PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} ,$$

the spatial relationship of the MU-MIMO UEs 22 in consideration may be obtained from the set {d_{i,j}}, i≠j from Step 1 by the following principles:
For the first UE 22:
   In one example, to establish the first UE 22 in the spatial relationship, the UE 22 may be chosen from the UEs 22 associated with the max (d_{i,j}). The UE 22 chosen in this case may essentially represents a UE 22 at the “edge” of the MU-MIMO group. In another example, the UE 22 may be chosen from the UE 22 with the min (d_{i,j}). As explained below, this may guarantee that the worst-case scenario in which the UEs 22 associated with min (d_{i,j}) is assigned orthogonal DMRS ports is prevented;
For the second UE 22:
   No matter how the first UE 22 was chosen, the second UE 22 to be established in the spatial relationship may be chosen based on the minimum distance associated with the first chosen UE 22;
From the third UE 22 and onwards:
   For the remaining UEs 22 to be established in the spatial relationship of the MU-MIMO group, the network node 16 may consider the following factors:
      The pairwise PMIDs between one or more of the (previously chosen) UEs 22;
      The interferences of the same DMRS port(s) contributed from the previously chosen UEs 22, which may be translated by the pairwise PMIDs or orthogonality factors;
      The interferences of the same code division multiplex (CDM) group(s) contributed from the previously chosen UEs 22, which may be translated by the pairwise PMIDs or orthogonality factors; and/or
      A combination of two or more of the above.

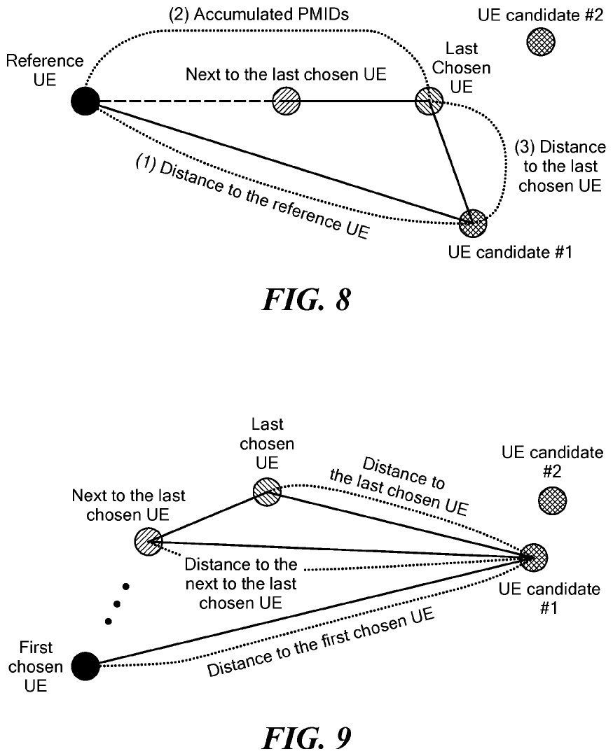

In one example, to make sure that each chosen UE 22 from the third and onwards is further away from the previously chosen UEs 22, the network node 16 may follow the steps below:
Step (i): Set the reference UE 22 to be the first chosen UE 22, and the accumulated PMID as the PMID between the first and the second chosen UEs 22;
Step (ii): Check each UE candidate i to determine whether the associated decision metric Dᵢ≥0 or not. Admit the UE 22 into a decision pool only if Dᵢ≥0. Specifically, the decision metric Dᵢ for the UE candidate i is illustrated in FIG. 8 and may be defined as:
Dᵢ=(1) the distance from the UE candidate i to the reference UE, minus (2) the accumulated PMIDs from the reference UE 22 to the last chosen UE 22, minus (3) the PMID from the last chosen UE 22 to the UE candidate i. Specifically, the accumulated PMIDs=PMID (from the reference UE 22 to the next chosen SE)+ . . . +PMID (Next to the last chosen UE 22 to the last chosen UE 22);
Step (iii): In case the decision pool is empty while all the UE candidates are exhausted, update the reference UE 22 as the last chosen UE 22 and the accumulated PMID to be 0. Then repeat Step (ii);
Step (iv): From the decision pool, select the UE candidate with the minimum PMID towards the last chosen UE 22. Update the accumulated PMID accordingly; and
Step (v): Go back to Step (ii) for the next UE 22 until the spatial relationship of all the UEs 22 in the MU-MIMO group is established.

In another example, the network node 16 may follow the steps below;
Step (i): Calculate each UE candidate i's decision metric Dᵢ which is the sum of the PMIDs of the candidate i to the previously selected UEs 22. Specifically, the decision metric Dᵢ for the UE candidate i is illustrated in FIG. 9 and may be defined as:
Dᵢ=PMID (UE candidate i to the first chosen UE 22)+ . . . +PMID (UE candidate i to the next to the last chosen UE 22)+PMID (UE candidate i to the last chosen UE 22);
Step (ii): Select the UE candidate with the min (Dᵢ); and/or
Step (iii); Go back to Step (i) for the next UE 22 until the spatial relationship of all the UEs 22 in the MU-MIMO group is established.

Note that it is possible that more than one UE 22 meets the selection criteria above (e.g., if there are multiple UEs 22 reaching the same min (Dᵢ)), possibly due to the UEs 22 being co-located together, or due to the beam granularity from the codebook being too coarse to distinguish between the UEs 22 in consideration, etc. The network node 16 may therefore introduce some randomization factors associated with the UEs 22 in consideration to facilitate the decision process, for example:
Physical cell ID (PCID): for UEs 22 in the cell edge that may perceive signaling from multiple network nodes, the introduction of PCID provides an additional randomization factor;
PMI information i_{1,3}: one of the PMI indices reported from the UE 22 that describes the additional beam information such as the relationship of two orthogonal beams;
PMI information i₂: one of the PMI indices reported from the UE 22 that describe the co-phasing terms:
CQI: part of the CSI report from the UE 22 to indicate the perceived channel quality;
Timing advance;
Received preamble power;
UL pathloss;
TTI: current TTI may be also introduced so that the selection becomes TTI-based; and/or.
A combination of two or more of the above.

In one example, the randomization factor associated with the UE candidate i may be described as:

$${( - 1 )}^{( PCID mod 2 )} {( - 1 )}^{( TTI mod 2 )} ( {i}_{1 , 3 , i} + {i}_{2 , i} ) .$$

Hence, if UE candidates i and j both arrive at the minimum of the decision metric, the network node 16 may choose UE candidate i if the UE's associated randomization factor is larger compared to that of the UE candidate j, that is:

$${( - 1 )}^{( PCID mod 2 )} {( - 1 )}^{( TTI mod 2 )} ( {i}_{1 , 3 , i} + {i}_{2 , i} ) > {( - 1 )}^{( PCID mod 2 )} {( - 1 )}^{( TTI mod 2 )} ( {i}_{1 , 3 , j} + {i}_{2 , j} ) .$$

Note that the above decision outcome may be different if different TTI's or PCID's are considered. In some embodiments, a CSI report may only be updated every 20 ms or so. Therefore, the introduction of the TTI in the randomization mechanism may ensure that the decision is different in every TTI. In case there are more than 2 UE candidates arriving at the minimum of the decision metric, the network node 16 may for example use a bubble search to reach the final decision.

### Step 3: Apply Obtained Spatial Relationship to Application

Once the spatial relationship of the UEs 22 in consideration has been established in Step 2, applications such as UEs 22 beamforming-based sectorization, DMRS ports selection, etc., may then be applied accordingly.

### Example

In one of the Over-The-Air (OTA) trials to measure the Type-1 codebook-based MU-MIMO total throughput, 4 MU-MIMO UEs 22 are all with the same CSI-RS configuration (N₁, N₂)=(8, 2). UE1, UE2, UE3, and UE4 are all placed in the same vertical heights (i.e., all the i12's are 0's) but placed apart with their i11's from the CSI report given as 19, 26, 0, and 6, respectively. The DMRS configuration is “1+1”.

Let \hat{d}_{i,j} denote the pairwise PMID between the UE i and the UE j. Their pairwise PMIDs may therefore be calculated as follows:

$${\hat{d}}_{1 , 2} = 7 , {\hat{d}}_{1 , 3} = 13 , {\hat{d}}_{1 , 4} = 13 , {\hat{d}}_{2 , 3} = 6 , {\hat{d}}_{2 , 4} = 12 , {\hat{d}}_{3 , 4} = 6.$$

Applying a sorting of the pairwise PMIDs in descending order, results in: \hat{d}_{1,3}≥\hat{d}_{1,4}>\hat{d}_{2,4}>\hat{d}_{1,2}>\hat{d}_{2,3}≥\hat{d}_{3,4}. Their PMIDs may be tabulated as follows:

| | UE1 | UE2 | UE3 | UE4 |
|---|---|---|---|---|
| UE1 | x | 7 | 13 | 13 |
| UE2 | 7 | x | 6 | 12 |
| UE3 | 13 | 6 | x | 6 |
| UE4 | 13 | 12 | 6 | x |

The spatial relationship may be established by the following:
Determine the 1^{st} UE
   accuPMIDs=0.
   Choose from \hat{d}_{1,3} for the first UE
      Choose UE1 if (−1)^{(PCID mod 2)}(−1)^{(TTI mod 2)}(i_{1,3,1}+i_{2,1})>(−1)^{(PCID mod 2)}(−1)^{(TTI mod 2)}(i_{1,3,3}+i_{2,3}) (we assume UE1 is the 1^{st} UE to continue)
      Otherwise, choose UE3
Determine the 2^{nd} UE
   Given UE1 is the 1^{st} SE, compare \hat{d}_{1,2} and \hat{d}_{1,4}
      Choose UE2 as the 2^{nd} UE because \hat{d}_{1,2}=7<\hat{d}_{1,4}=13
      accuPMIDs=\hat{d}_{1,2}=7
Determine the 3^{rd} UE
   Given UE1 is the 1^{st} UE and UE2 is the 2^{nd} UE, there are two possible candidates UE3 and UE4 as the 3^{rd} UE.
      The decision metric for UE3 is D₃=\hat{d}_{1,3}−accuPMIDs−\hat{d}_{2,3}=13−7−6=0≥0.
      The decision metric for UE4 is D₄=\hat{d}_{1,4}−accuPMIDs−\hat{d}_{2,4}=13−7−12=−6<0.
      Choose UE3 as the 3^{rd} UE because UE3 is the only candidate in the decision pool and meeting the requirement.
Determine the 4^{th} UE.
   The 4^{th} UE is the UE4.

The spatial relationship of the MU-MIMO group is therefore UE1→UE2→UE3→UE4.

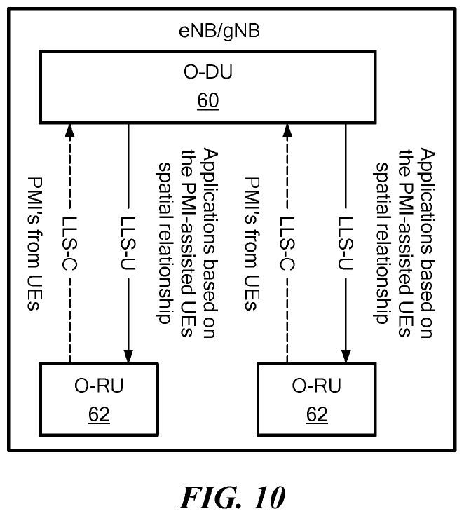

The PMI-assisted UE spatial relationship establishment may be implemented in Open Radio Access Network (O-RAN) for various 5G NR applications, e.g., O-RAN distributed unit (O-DU) 60 in an O-RAN architecture as shown in FIG. 10. In one example, PMI's from UEs 22 may be indicated from the O-RAN radio unit (O-RU) 62 to O-DU 60 per CSI report. In another example, the PMI information or other similar measure for the purpose of establishing the UE spatial relationship may be decoded in O-DU 60. Both O-RU Category A (Non-precoding O-RAN Radio Unit) and Category B (Precoding O-RAN Radio Unit) may be applicable. For the application such as DL MU-MIMO DMRS port selection, the main difference may lie in whether lower layer splits (LLS-U) carries beamformed or non-beamformed physical downlink shared channel (PDSCH) and PDSCH DMRS. For the application such as determining beamforming sectorization, the differences between O-RU Category A or Category B may be minor.

Some embodiments may include one or more of the following:

Embodiment A1. A network node configured to communicate with a user equipment (UE), the network node configured to, and/or comprising a radio interface and/or comprising processing circuitry configured to:
receive a plurality of precoding matrix indicators, PMI, from a plurality of UEs;
determine harmonized PMI among the received PMI; and
establish a spatial relationship for UEs from which the harmonized PMI are received based at least in part on the harmonized PMI.

Embodiment A2. The network node of Embodiment A1, wherein establishing the spatial relationship for the UEs includes projecting the harmonized PMIs to a reference line.

Embodiment A3. The network node of Embodiment A2, wherein establishing the spatial relationship for the UEs includes sorting the projected harmonized PMIs into a predetermined method of order.

Embodiment A4. The network node of any of Embodiments A1-A3, wherein establishing the spatial relationship for the UEs includes selecting a first UE associated with one of a maximum value and a minimum value of a distance parameter based on the harmonized PMIs.

Embodiment A5. The network node of Embodiment A3, wherein establishing the spatial relationship for the UEs includes selecting a second UE associated with a minimum value of the distance parameter.

Embodiment A6. The network node of any of Embodiments A3 and A4, wherein the distance parameter is based at least in part on a determined value of:

$${d}_{i , j} = PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} ;$$

where (l′ᵢ, m′ᵢ) indicate respective horizontal and vertical beam indices and β is a factor based at least in part on the harmonized PMI.

Embodiment A7. The network node of Embodiment A5, wherein establishing the spatial relationship includes selecting remaining UEs based at least in part on the distance parameter of each remaining UE.

Embodiment A8. The network node of Embodiment A6, wherein selecting a remaining UE includes comparing the distance parameter to a distance parameter of the first UE.

Embodiment A9. The network node of Embodiment A6, wherein selecting a remaining UE includes selecting a UE associated with a minimum value of the distance parameter.

Embodiment B1. A method implemented in a network node that is configured to communicate with a wireless device, the method:
receiving a plurality of precoding matrix indicators, PMI, from a plurality of UEs;
determining harmonized PMI among the received PMI; and
establishing a spatial relationship for UEs from which the harmonized PMI are received based at least in part on the harmonized PMI.

Embodiment B2. The method of Embodiment B1, wherein establishing the spatial relationship for the UEs includes projecting the harmonized PMIs to a reference line.

Embodiment B3. The method of Embodiment B2, wherein establishing the spatial relationship for the UEs includes sorting the projected harmonized PMIs into a predetermined method of order.

Embodiment B4. The method of any of Embodiments B1-B3, wherein establishing the spatial relationship for the UEs includes selecting a first UE associated with one of a maximum value and a minimum value of a distance parameter based on the harmonized PMIs.

Embodiment B5. The method of Embodiment B3, wherein establishing the spatial relationship for the UEs includes selecting a second UE associated with a minimum value of the distance parameter.

Embodiment B6. The method of any of Embodiments B3 and B4, wherein the distance parameter is based at least in part on a determined value of:

$${d}_{i , j} = PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} ;$$

where (l′ᵢ, m′ᵢ) indicate respective horizontal and vertical beam indices and β is a factor based at least in part on the harmonized PMI.

Embodiment B7. The method of Embodiment B5, wherein establishing the spatial relationship includes selecting remaining UEs based at least in part on the distance parameter of each remaining UE.

Embodiment B8. The method of Embodiment B6, wherein selecting a remaining UE includes comparing the distance parameter to a distance parameter of the first UE.

Embodiment B9. The method of Embodiment B6, wherein selecting a remaining UE includes selecting a UE associated with a minimum value of the distance parameter.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AAS Active Antenna System
CSI-RS Channel State Information Reference Signal
DFT Discrete Fourier Transform
DMRS Demodulation reference Signal
MIMO Multiple-Input Multiple-Output
MU Multiple Users
O-DU O-RAN Distributed Unit
O-RU O-RAN Radio Unit
ORAN Open RAN
PMI Precoding Matrix Indicator
PMID Precoding Matrix Indicator (PMI) Distance

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A network node (16) configured to communicate with a user equipment (UE) (22), the network node (16) including processing circuitry configured to:
receive a plurality of precoding matrix indicators, PMI, from a plurality of UEs (22);
determine harmonized PMI among the received PMI; and
establish a spatial relationship for UEs (22) from which the harmonized PMI are received based at least in part on the harmonized PMI.

2. The network node (16) of claim 1, wherein establishing the spatial relationship for the UEs (22) includes projecting the harmonized PMIs to a reference line.

3. The network node (16) of claim 2, wherein establishing the spatial relationship for the UEs (22) includes sorting the projected harmonized PMIs into a predetermined method of order.

4. The network node (16) of any of claims 1-3, wherein establishing the spatial relationship for the UEs (22) includes selecting a first UE (22) associated with one of a maximum value and a minimum value of a distance parameter based at least in part on the harmonized PMIs.

5. The network node (16) of claim 4, wherein establishing the spatial relationship for the UEs (22) includes selecting a second UE (22) associated with the minimum value of the distance parameter.

6. The network node (16) of any claims 4 and 5, wherein the distance parameter is based at least in part on a determined value of:
$${d}_{i , j} = PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} ;$$
where (l′ᵢ, m′ᵢ) indicate respective horizontal and vertical beam indices and β is a factor based at least in part on the harmonized PMI.

7. The network node (16) of claim 6, wherein establishing the spatial relationship includes selecting remaining UEs (22) based at least in part on the distance parameter of each remaining UE (22).

8. The network node (16) of claim 7, wherein selecting a remaining UE (22) includes comparing the distance parameter to the distance parameter of the first UE (22).

9. The network node (16) of claim 7, wherein selecting a remaining UE (22) includes selecting a UE (22) associated with the minimum value of the distance parameter.

10. The network node (16) of any of claims 1-9, wherein the processing circuitry is further configured to determine a beam direction based at least in part on the harmonized PMI.

11. A method implemented in a network node (16) that is configured to communicate with a user equipment, the method:
receiving (S10) a plurality of precoding matrix indicators, PMI, from a plurality of UEs (22);
determining (S12) harmonized PMI among the received PMI; and
establishing (S14) a spatial relationship for UEs (22) from which the harmonized PMI are received based at least in part on the harmonized PMI.

12. The method of claim 11, wherein establishing the spatial relationship for the UEs (22) includes projecting the harmonized PMIs to a reference line.

13. The method of any of claims 11 and 12, wherein establishing the spatial relationship for the UEs (22) includes sorting the projected harmonized PMIs into a predetermined method of order.

14. The method of any of claims 11-13, wherein establishing the spatial relationship for the UEs (22) includes selecting a first UE (22) associated with one of a maximum value and a minimum value of a distance parameter based at least in part on the harmonized PMIs.

15. The method of claim 14, wherein establishing the spatial relationship for the UEs (22) includes selecting a second UE (22) associated with the minimum value of the distance parameter.

16. The method of any of claims 14 and 15, wherein the distance parameter is based at least in part on a determined value of:
$${d}_{i , j} = PMID ( ( {l}_{i}^{′} , {m}_{i}^{′} ) , ( {l}_{j}^{′} , {m}_{j}^{′} ) ) = \sqrt[n]{{\vert {l}_{i}^{′} - {l}_{j}^{′} \vert}^{n} + β {\vert {m}_{i}^{′} - {m}_{j}^{′} \vert}^{n}} ;$$
where (l′ᵢ, m′ᵢ) indicate respective horizontal and vertical beam indices and β is a factor based at least in part on the harmonized PMI.

17. The method of any of claims 15 and 16, wherein establishing the spatial relationship includes selecting remaining UEs (22) based at least in part on the distance parameter of each remaining UE (22).

18. The method of claim 17, wherein selecting a remaining UE (22) includes comparing the distance parameter to the distance parameter of the first UE (22).

19. The method of claim 15, wherein selecting a remaining UE (22) includes selecting a UE (22) associated with the minimum value of the distance parameter.

20. The method of any of claims 11-19, further comprising determining a beam direction based at least in part on the harmonized PMI.
